(19) United States
(12) Patent Application Publication
(10) Pub. No.: US 2025/0066656 A1
(43) Pub. Date: Feb. 27, 2025

(54) SALT HYDRATE-BASED THERMAL ENERGY STORAGE MATERIAL WITH NEAR-AMBIENT PHASE CHANGE TEMPERATURE

(71) Applicant: UT-Battelle, LLC, Oak Ridge, TN (US)

(72) Inventors: Tugba Turnaoglu, Knoxville, TN (US); Kyle R. Gluesenkamp, Knoxville, TN (US)

(21) Appl. No.: 18/810,724

(22) Filed: Aug. 21, 2024

Related U.S. Application Data
(60) Provisional application No. 63/534,589, filed on Aug. 25, 2023.

(51) Int. Cl. C09K 5/06; F28D 20/02

(52) U.S. Cl. CPC C09K 5/063; F28D 20/02

(57) ABSTRACT

A phase change material composition for latent heat storage is provided. The composition includes a eutectic mixture of two or more salt hydrates, and at least one salt additive each selected from a bromide salt and a bromide salt hydrate. The mixture of salt hydrates has a melting temperature above room temperature. The at least one salt additive decreases the melting temperature of the mixture and reduces a degree of supercooling of the mixture. The mixture of salt hydrates may be a mixture of calcium chloride hexahydrate and magnesium chloride hexahydrate. The salt additives may include both calcium bromide and magnesium bromide. The melting temperature of the phase change material composition may be in a range of approximately 15 to 25° C. A thermal energy storage system including the phase change material composition and a method of heat management in the thermal energy storage system are also provided.

### CROSS-REFERENCE TO RELATED APPLICATIONS

This application claims the benefit of U.S. Provisional Application No. 63/534,589, filed Aug. 25, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to thermal energy storage, and more particularly to phase change materials for latent heat storage.

### BACKGROUND OF THE INVENTION

Phase change materials (PCMs) have been used in a range of thermal storage and temperature control applications for many years. PCMs can provide thermal mass to dampen temperature extremes for any thermally cyclic system. This is important to thermally sensitive systems where large and sudden temperature swings are undesirable. Examples include incorporation of PCMs into building envelopes and materials, clothing and textiles, electronics, batteries, solar photovoltaics, and HVAC and refrigeration systems.

Buildings are one of the most energy-intensive sectors and a major contributor to carbon dioxide emissions while accounting for one-third of energy consumption worldwide. Thus, significant energy and carbon emission reductions in buildings are critical. Among all sources of building energy consumption including heating and cooling systems, lighting, ventilation systems, and major appliances, HVAC (heating, ventilation, and air conditioning) systems account for almost half of the energy consumed in buildings. Thermal energy storage (TES) has received significant attention due to offering a sustainable solution to grid resilience and energy savings when it is integrated into heat exchangers or heat pumps in buildings. Particularly, TES assists in controlling the peak energy demand by utilizing the stored energy to manage high-demand hours. One of the integral elements in TES deployment in building heating/cooling systems is the development of low-cost, near ambient melting point, high-performance, and durable materials for optimal performance.

Among TES materials, salt hydrates as phase change materials (PCMs) are attractive due to their abundance, cost-effectiveness, non-flammability, and non-toxicity. In latent heat storage (LHS), one of the most common thermal energy storage systems, energy is stored or released on melting (energy in) and freezing (energy out) of the PCMs such as melting and freezing of salt hydrates. However, salt hydrates are prone to phase separation and instability due to incongruent melting (i.e., incongruency), as well as supercooling due to delayed nucleation. Supercooling reduces the full utilization of the latent heat storage of PCMs. Phase instability and phase separation can result in significant degradation of the PCM's thermal energy storage capacity over extended freeze/melt cycles. In particular, the latent heat of a PCM is the thermal energy required to complete a change of phase of the PCM at its melting/freezing point. When a salt hydrate undergoes melting, water molecules present in the crystal structure of the solid are released and become liquid water; an aqueous salt solution is formed as a result of this transformation. If the salt is completely soluble in the released water, the salt hydrate is said to melt congruently. If the salt is only partially soluble, some anhydrous salt will form along with a saturated salt solution. In this case, the salt hydrate is said to melt incongruently, and the anhydrous salt will precipitate from the solution. In many cases, the stoichiometric water content present in a hydrate is not sufficient to allow the anhydrous salt to dissolve completely into a homogeneous aqueous solution. The salt's insolubility in the stoichiometric water of its hydrate causes incongruent melting, whereby anhydrous salt settles out of solution and fails to recombine with water upon freezing. Further, due to differences in density between the salt solution and the solid anhydrous salt, the solid particles tend to separate and settle out of the saturated aqueous solution. This phenomenon is referred to as phase separation. Upon freezing, water molecules reform the aforementioned crystal structure with the dissolved salt ions. One melting and one freezing process constitutes a thermal cycle. For incongruently melting salt hydrates, the anhydrous salt that separated upon melting may not reform with the water present into the original salt hydrate crystal structure. Instead, the anhydrous salt remains separated from the newly formed salt hydrate, and saturated aqueous solution or water will also remain. As such, the latent heat associated with the freezing process is less than that associated with the previous melting process since less material actually undergoes the phase transition during the freezing due to the phase separation. This represents a degradation of thermal energy storage capacity of the material upon thermal cycling. Repeated thermal cycling can exacerbate the degradation as phase separation continues.

A phase change material with a near-room-temperature melting point is particularly important in heating and cooling applications because the material can absorb and release thermal energy at temperatures close to the desired room temperature. Such a phase change material can help regulate the temperature in a room or building without requiring significant amounts of energy to heat or cool the material to its melting point. Accordingly, there remains a continued need for an improved phase change material composition for latent heat storage that has a melting point at or near ambient/room temperature.

### SUMMARY OF THE INVENTION

A phase change material composition for latent heat storage is provided. The phase change material composition includes a mixture of two or more salt hydrates. The mixture of two or more salt hydrates has a melting temperature near or above room temperature. The phase change material composition further includes at least one salt additive. Each salt additive is one selected from a bromide salt and a bromide salt hydrate. The at least one salt additive decreases the melting temperature of the mixture and reduces a degree of supercooling of the mixture.

In specific embodiments, the mixture of two or more salt hydrates is a eutectic mixture.

In specific embodiments, the mixture of two or more salt hydrates is a mixture of calcium chloride hexahydrate (CaCl₂·6H₂O) and magnesium chloride hexahydrate (MgCl₂·6H₂O).

In particular embodiments, the mixture of calcium chloride hexahydrate and magnesium chloride hexahydrate is an approximately 90:10 mixture by weight.

In specific embodiments, the at least one salt additive includes one or more of: calcium bromide (CaBr₂), magnesium bromide (MgBr₂), strontium bromide (SrBr₂), strontium bromide hydrate (SrBr₂·nH₂O), potassium bromide (KBr), and sodium bromide (NaBr).

In specific embodiments, the at least one salt additive includes both calcium bromide and magnesium bromide.

In specific embodiments, each salt additive has a divalent cation.

In specific embodiments, each salt additive is present in an amount in a range of approximately 1 to 9 percent by weight based on a total weight of the phase change material composition.

In particular embodiments, each salt additive is present in an amount of approximately 5 percent by weight based on a total weight of the phase change material composition.

In specific embodiments, the melting temperature of the phase change material composition is in a range of approximately 15 to 25° C.

In specific embodiments, the degree of supercooling of the phase change material composition is approximately 15° C. or less.

In specific embodiments, a latent heat of the phase change material composition is in a range of approximately 120 to 170 J/g.

A thermal energy storage system including the phase change material composition is also provided.

In specific embodiments, the thermal energy storage system includes one of a heating/cooling unit and building insulation.

In particular embodiments, the heating/cooling unit is a heat pump.

A method of heat management in a thermal energy storage system is also provided. The method includes providing the phase change material composition according to any of the embodiments above. The method further includes the step of exchanging thermal energy between the phase change material composition and another medium. The phase change material composition stores and releases thermal energy at or near room temperature.

In specific embodiments of the method, the thermal energy storage system includes one of a heating/cooling unit and building insulation.

In particular embodiments of the method, the heating/cooling unit is a heat pump.

These and other features of the invention will be more fully understood and appreciated by reference to the description of the embodiments and the drawings.

### BRIEF DESCRIPTION OF THE DRAWINGS

FIG. 1 is a schematic view of a thermal energy storage system including a phase change material composition in accordance with embodiments of the disclosure;

FIG. 2 is a graph of the melting temperature (in degrees Celsius) and melting enthalpy (in Joules per gram) for various combinations of salt additives with a binary eutectic mixture of 90:10 weight percent of calcium chloride hexahydrate (CCH) and magnesium chloride hexahydrate (MCH);

FIG. 3 is a graph of peak melting temperature (in degrees Celsius) and melting enthalpy (in Joules per gram) at various weight percent additions of calcium bromide (CB) to the binary eutectic mixture of 90:10 CCH:MCH;

FIG. 4A is a graph of differential scanning calorimetry (DSC) data illustrating a degree of supercooling of the binary eutectic mixture of 90:10 CCH:MCH;

FIG. 4B is a graph of DSC data illustrating a degree of supercooling of the binary eutectic mixture of 90:10 CCH:MCH mixed with 9 percent by weight CB;

FIG. 5 is a graph of DSC data illustrating heat flow (in Watts per gram) as a function of temperature (in degrees Celsius) from which melting enthalpy (in Joules per gram) is calculated for Example I in accordance with embodiments of the disclosure; and

FIG. 6 is a graph of DSC data illustrating the phase transition temperature of Example I in comparison to the binary eutectic mixture of 90:10 CCH:MCH.

### DETAILED DESCRIPTION OF THE CURRENT EMBODIMENTS

A phase change material composition for latent heat storage, a thermal energy storage system including the same, and a method of heat management in a thermal energy storage system are provided. The phase change material composition has a phase change temperature (specifically a melting temperature) that is at or near ambient, room temperature. The phase change material composition may also exhibit excellent thermal cycling stability and high energy storage capacity. The phase change material composition may further exhibit congruent melting and thereby avoid phase separation, which improves cycling stability. The phase change material composition is suitable in a variety of applications including, but not limited to, any application in which thermal energy storage is desirable, such as building heating/cooling (HVAC) and/or insulation applications.

The phase change material composition includes a mixture of two or more salt hydrates. Salts hydrates are the result of an anhydrous salt forming a solid crystalline structure in the presence of water in specific molar ratios. Depending on the ionic structure of the salt, a finite number of hydrates can form and often only one or two of these is thermodynamically stable. For example, calcium chloride (CaCl₂) forms two hydrates: the hexahydrate (CaCl₂·6H₂O) and tetrahydrate (CaCl₂·4H₂O). Salt hydrates melt when the solid crystal structure releases its water and forms an aqueous solution, and salt hydrates generally have well-defined discrete melting temperatures from the solid to liquid phase. In this example, the two calcium chloride hydrates have different melting temperatures that depend on the water content; the hexahydrate (CaCl₂·6H₂O) has a melting temperature of about 30° C. whereas the tetrahydrate (CaCl₂·4H₂O) has a melting temperature of about 44° C. The melting temperature (Tₘ) of the salt hydrate may be determined, for example, in accordance with ASTM E794, which is incorporated by reference herein in its entirety.

The mixture of salt hydrates typically has a phase change temperature, particularly a melting temperature (Tₘ), that is greater than room temperature. Room temperature, which may also be referred to as ambient temperature, is generally defined as being in a range of approximately 20° C. to 22° C., and more broadly may be in a range of approximately 20° C. to 25° C. The mixture of salt hydrates is preferably a eutectic mixture. A eutectic mixture is defined as a mixture of at least two solid components having a single phase change temperature, which corresponds to the minimum melting temperature of the different possible compositions for a given mixture. A eutectic mixture will therefore have a lower melting temperature than the melting temperature of any of the individual components of the mixture.

Non-limiting examples of suitable salt hydrates include lithium chlorate trihydrate (LiClO₃·3H₂O), dipotassium hydrogen phosphate hexahydrate (K₂HPO₄·6H₂O), potassium fluoride tetrahydrate (KF·4H₂O), manganese nitrate hexahydrate (Mn(NO₃)₂·6H₂O), calcium chloride hexahydrate (CaCl₂·6H₂O), magnesium chloride hexahydrate (MgCl₂·6H₂O), sodium sulfate decahydrate (Na₂SO₄·10H₂O), sodium hydrogen phosphate dodecahydrate (Na₂HPO₄·12H₂O), zinc nitrate hexahydrate (Zn(NO₃)₂·6H₂O), iron (III) chloride hexahydrate (FeCl₃·6H₂O), calcium chloride tetrahydrate (CaCl₂·4H₂O), calcium nitrate tetrahydrate (Ca(NO₃)₂·4H₂O), sodium thiosulfate pentahydrate (Na₂S₂O₃·5H₂O), sodium acetate trihydrate (C₂H₃NaO₂·3H₂O).

In some embodiments, the mixture of salt hydrates is a mixture of calcium chloride hexahydrate (CaCl₂·6H₂O) and magnesium chloride hexahydrate (MgCl₂·6H₂O), and preferably the mixture of calcium chloride hexahydrate and magnesium chloride hexahydrate is a eutectic mixture that is approximately 90% by weight (wt. %) calcium chloride hexahydrate and approximately 10% by weight (wt. %) magnesium chloride hexahydrate. The 90:10 wt. % mixture of calcium chloride hexahydrate and magnesium chloride hexahydrate has the lowest melting point temperature for the combination of calcium chloride hexahydrate with magnesium chloride hexahydrate.

The phase change material composition further includes at least one salt additive. In various embodiments, the phase change material composition includes two or more of the salt additives. Preferably, each salt additive is a bromide salt or a bromide salt hydrate. As described in more detail below, the bromide salt(s) unexpectedly and advantageously reduce the melting temperature of the mixture and reduce the supercooling effect. Examples of suitable bromide salts and bromide salt hydrates include, but are not limited to, calcium bromide (CaBr₂), magnesium bromide (MgBr₂), strontium bromide (SrBr₂), strontium bromide hydrate (SrBr₂·nH₂O), potassium bromide (KBr), and sodium bromide (NaBr). The salt additives may also include a chloride salt. Each salt additive may have a monovalent (1+) or divalent (2+) cation, but preferably each salt additive has a divalent cation. In some embodiments, the salt additives are calcium bromide and magnesium bromide. Each salt additive may be present in an amount in a range of approximately 1% to 9% by weight (wt. %) based on a total weight of the phase change material composition, or if other additional components are included in the phase change material composition, based on a total combined weight of the mixture of salt hydrates and the salt additive(s). For example, the phase change material composition may include 3 wt. % of a salt additive A, 5 wt. % of a salt additive B, and the balance the 90:10 mixture of calcium chloride hexahydrate and magnesium chloride hexahydrate (92 wt. % of the 90:10 salt hydrate mixture). Optionally, each salt additive is present in an amount in a range of approximately 2 to 9 wt. %, optionally 2 to 8 wt. %, optionally 2 to 7 wt. %, optionally 3 to 9 wt. %, optionally 3 to 8 wt. %, optionally 3 to 7 wt. %, optionally 4 to 9 wt. %, optionally 4 to 8 wt. %, optionally 4 to 7 wt. %, optionally 5 to 9 wt. %, optionally 5 to 8 wt. %, optionally 5 to 7 wt. %, optionally 1 to 7 wt. %, optionally 1 to 6 wt. %, optionally 1 to 5 wt. %, optionally 2 to 5 wt. %, optionally 3 to 5 wt. %. In specific embodiments, each salt additive is present in an amount of approximately 5% by weight based on a total weight of the phase change material composition, or if other additional components are included in the phase change material composition, based on a total combined weight of the mixture of salt hydrates and the salt additive(s).

The one or more salt additives advantageously decrease the melting temperature of the salt hydrate mixture and also simultaneously reduce a degree of supercooling of the mixture such that the phase change material composition has a melting temperature that is less than the melting temperature of the salt hydrate mixture alone and the phase change material composition has a degree of supercooling that is less than the degree of supercooling of the salt hydrate mixture alone. The resulting melting temperature of the phase change material composition is at or near room temperature, with at or near room temperature generally being in a range of 20° C. to 25° C. In certain embodiments, the melting temperature of the phase change material composition may be less than room temperature, in other words, less than approximately 20° C. In some embodiments, the melting temperature of the phase change material composition may be in a range of approximately 15° C. to 25° C., optionally 15° C. to 24° C., optionally 15° C. to 23° C., optionally 15° C. to 22° C., optionally 16° C. to 25° C., optionally 17° C. to 25° C., optionally 18° C. to 25° C., optionally 19° C. to 25° C. For example, the melting temperature of the mixture of salt hydrates may be approximately 27.5° C. (above room temperature), and the resulting melting temperature of the phase change material composition including the mixture of salt hydrates and the one or more salt additives may be approximately 22° C. (at room temperature). The resulting degree of supercooling of the phase change material composition may be approximately 15° C. or less, whereas the degree of supercooling of the salt hydrate mixture alone is greater, such as approximately 40° C.

The phase change material may have a latent heat of melting (melting enthalpy) that is in a range of approximately 100 to 200 J/g, optionally 100 to 190 J/g, optionally 100 to 180 J/g, optionally 100 to 170 J/g, optionally 100 to 160 J/g, optionally 100 to 150 J/g, optionally 110 to 190 J/g, optionally 120 to 180 J/g, optionally 120 to 170 J/g, optionally 130 to 180 J/g, optionally 130 to 170 J/g, optionally 140 to 180 J/g, optionally 140 to 170 J/g. The melting enthalpy may be determined, for example, in accordance with ASTM E793, which is incorporated by reference herein in its entirety. Preferably, the melting enthalpy of the phase change material composition is near to or only marginally less than the melting enthalpy of the mixture of salt hydrates alone. For example, the melting enthalpy of the phase change material composition may be approximately 10 J/g less than the melting enthalpy of the mixture of salt hydrates included in the composition. However, the melting enthalpy of the phase change material composition may be more significantly less than the melting enthalpy of the mixture of salt hydrates alone, but still be at a value to provide suitable thermal energy storage capacity for the desired application. For example, the melting enthalpy of the phase change material composition may be approximately 125 J/g whereas the melting enthalpy of the mixture of salt hydrates is approximately 175 J/g.

Optionally, the phase change material composition may further include a thickener. The thickener may be any compound or material capable of increasing viscosity of the phase change material composition so long as the thickener is compatible with the components of the phase change material composition. Non-limiting examples of suitable thickeners include sodium polyacrylate, cellulose nanofiber, modified expanded graphite, or combinations thereof. The thickener may be present in the phase change material composition in any amount suitable for the desired application. In various embodiments, the thickener is present in an amount of from 1 to 99 wt. %, optionally 1 to 10 wt. %, or optionally 1 to 5 wt. %, based on a total weight of the phase change material composition.

Optionally, the phase change composition may further include a thermal conductivity enhancer. The thermal conductivity enhancer may be any compound or material capable of conducting heat within the phase change material composition so long as the thermal conductivity enhancer is compatible with the components of the phase change material composition. Non-limiting examples of suitable thermal conductivity enhancer include graphite flakes, carbon black, sulfonated reduced graphene oxide, or combinations thereof. The thermal conductivity enhancer may be present in the phase change material composition in any amount suitable for the desired application. In various embodiments, the thermal conductivity enhancer is present in an amount of from 1 to 99 wt. %, optionally 1 to 20 wt. %, or optionally 1 to 10 wt. %, based on a total weight of the phase change material composition.

Optionally, the phase change composition may also include other polymers, surfactants, or sorbent support materials (such as zeolites, alumina, silica, and the like) to improve the stability of the composition, as well as corrosion-reducing or corrosion-resistant materials to reduce or prevent corrosion of the composition. These further additional component(s) may be present in the phase change material composition in any amount suitable for the desired application. In various embodiments, these further additional component(s) is/are present in an amount of from 1 to 99 wt. %, optionally 1 to 20 wt. %, or optionally 1 to 10 wt. %, based on a total weight of the phase change material composition.

The phase change material composition may be prepared by mixing the two or more solid salt hydrates together in a desired ratio, preferably a ratio that forms a eutectic mixture, and further mixing the one or more solid salt additives with the mixture of two or more salt hydrates. The resulting mixture may then be placed in a water bath, raised to an elevated temperature above room temperature, for example a temperature in a range of 40° C. to 50° C., and further mixed such as by sonication in the water bath for a period of time in a range of 5 to 60 minutes, optionally 10 to 50 minutes, optionally 15 to 45 minutes, optionally 20 to 40 minutes. After sonication, the composition may be kept in an oven at the same or similar elevated temperature for a period of time of at least 30 minutes, optionally at least 1 hour.

A thermal energy storage system including the phase change material composition may include a heating/cooling unit (such as an HVAC unit) or building insulation. As such, the phase change material composition may be used in building applications in which the phase change material composition can absorb and release thermal energy at temperatures at or close to the desired room temperature during heating and cooling cycles. Therefore, the phase change material composition can aide in regulating the temperature in the rooms of a building without requiring significant amounts of energy to heat or cool the phase change material composition to its melting point. The phase change material composition thereby efficiently stores and releases thermal energy within the desired temperature range, and in turn enhances the overall performance, energy efficiency, and environmental sustainability of building heating/cooling systems.

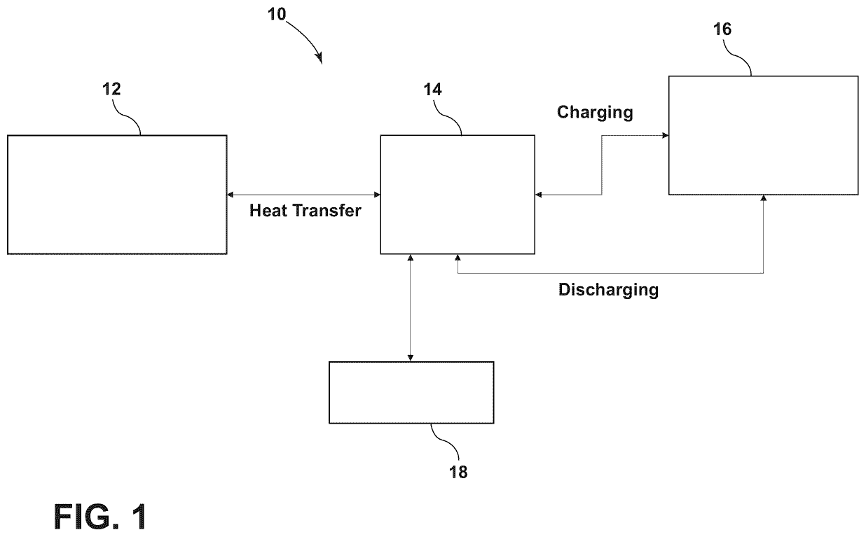

In exemplary embodiments, the thermal energy storage system is a building heating/cooling system including a heat pump. With reference to FIG. 1, the thermal energy storage system 10 includes a building 12 in which the temperature is regulated. Heat is transferred between a heat pump 14 and the building 12 to maintain the inside temperature of the building at a desired level. The phase change material composition 16 cooperates with the heat pump 14, and may be incorporated into the heat pump itself, may be part of a condenser or evaporator connected to the heat pump, or may be contained within a stand-alone storage tank that is coupled to the heat pump. During cooling of the building 12, the heat generated by the heat pump 14 has a temperature greater than the melting temperature of the phase change material composition 16. The phase change material composition 16 is thus charged by absorbing heat from the heat pump 14, causing the phase change material composition 16 to undergo a phase transition from solid to liquid (melting) resulting in the absorption of the heat. Oppositely, during warming of the building 12, the phase change material composition 16 is discharged by releasing heat to the heat pump 14 when the temperature of the phase change material composition 16 decreases to the freezing point of the phase change material composition 16, causing the phase change material composition to return to a solid state. The heat released to the heat pump 14 from the phase change material composition 16 is delivered by the heat pump to the building 12. In addition to exchanging heat with the phase change material composition 16, the heat pump 14 also transfers heat to and from the outdoor air (ambient) 18.

In other embodiments, the phase change material composition may be incorporated into insulation such as insulation boards or other insulative support material that can contain the phase change material composition. The insulation including the phase change material composition may then be used as the insulation in building walls to aide in regulating the temperature of the rooms of the building surrounded by the insulated walls.

### EXAMPLE

The present phase change material composition is further described in connection with the following laboratory example, which is intended to be non-limiting.

The following inorganic materials were used in this study: calcium chloride hexahydrate (CaCl₂·6H₂O, acronym used herein as CCH), magnesium chloride hexahydrate (MgCl₂·6H₂O, purity of 99.9%, acronym used herein as MCH), calcium bromide (CaBr₂, acronym used herein as CB), magnesium bromide (MgBr₂, acronym used herein as MB), potassium bromide, copper (I) bromide, potassium chloride, sodium chloride, zinc nitrate hexahydrate, and strontium chloride hexahydrate. All materials were ordered in small quantities to prevent interaction with humidity in an ambient environment and used as received.

All salt mixtures were prepared as follows. Known quantities of the materials were weighed using an analytical balance. The solid mixtures were sonicated in a water bath and at a temperature of 45° C. to 50° C. for a period of a few minutes to 30 minutes, thereby thoroughly mixing and completely melting the mixtures to ensure a high uniformity in a short amount of time.

The materials were characterized using differential scanning calorimetry (DSC). DSC is a robust, rapid, and reliable characterization method for phase change materials. The DSC measurements of the samples were performed using TA Instruments, DSC 2500. In the DSC measurements, approximately 10 mg of the melted sample was placed in hermetically sealed aluminum pans (TA Instruments TZero pan and TA Tzero hermetic lid). The samples underwent a plurality of melting and freezing cycles under constant nitrogen flow between −60° C. and 50° C. with a heating rate of 5° C./min. The heating curves (heat flow versus temperature) were analyzed to obtain a melting temperature and a melting enthalpy. The endothermic peak on the heating curve corresponding to the phase change material was calculated by integrating the peak in the curve. Both onset and peak temperatures were measured; however, the peak temperature of the PCM peak was reported as the melting temperature.

Various binary mixtures of CCH and MCH were prepared in order to determine the eutectic point for this binary salt hydrate mixture. Specifically, mixtures of CCH and MCH ranging from 0% CCH to 100% CCH by weight (wt. %) at 10% increments were prepared. The samples were left in an oven at 45° C. for 1 hour to visually observe their behavior. For the mixture in which the concentration of CCH was 90 wt. % and the concentration of MCH was 10 wt. %, the solution was transparent and there was no observed phase separation. Although the solubility of the components depends on temperature, this initial visual investigation indicated a potential congruent melting and eutectic point. The 90:10 CCH:MCH composition withstood 100 melting and freezing cycles without any observable energy losses. The melting temperature for this composition was measured at 27.5° C., which was higher than the desired threshold of 25° C. or below. Furthermore, a significant supercooling effect was evident, measured at an approximate value of 44° C. Thus, although the 90:10 CCH:MCH composition was stable, it had a large supercooling value. Supercooling reduces the full utilization of the latent heat storage due to a reduced freezing temperature which results in large temperature differences between the melting and freezing temperatures.

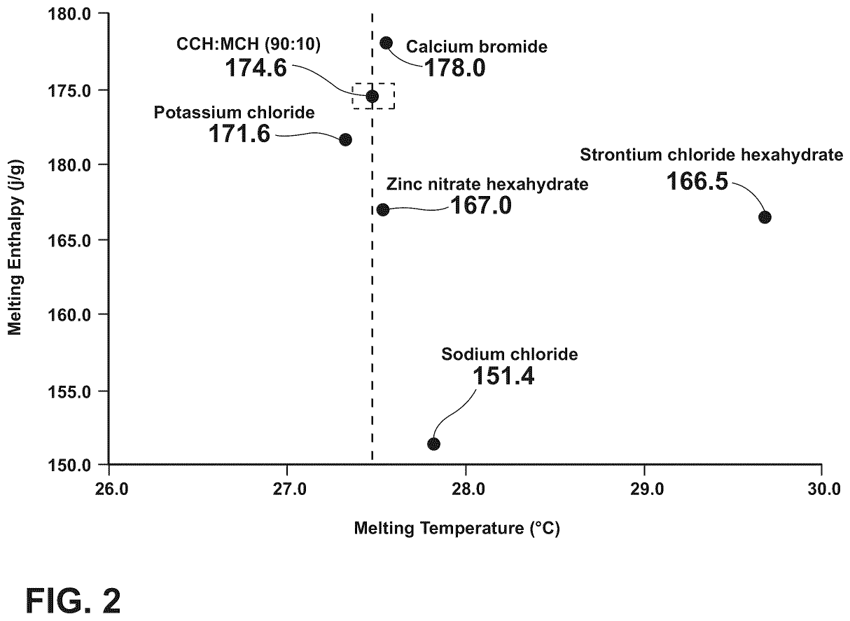

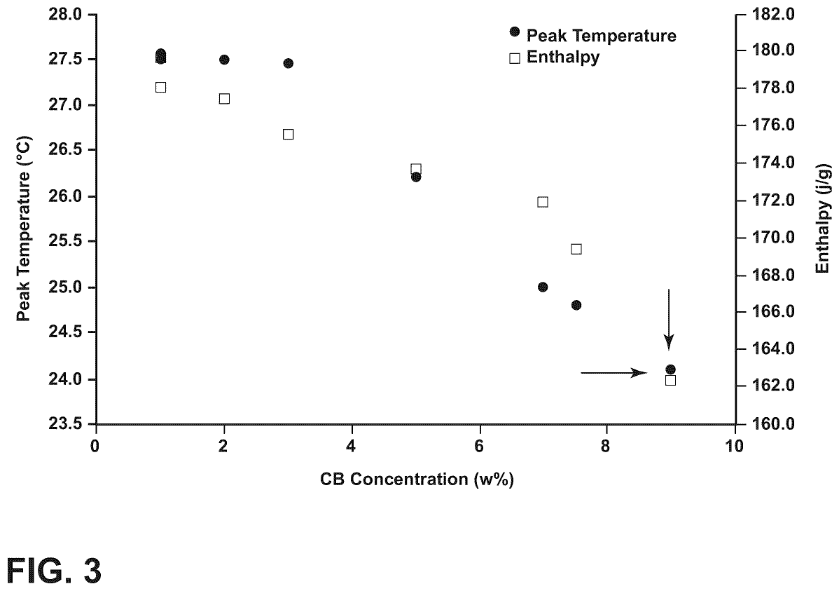

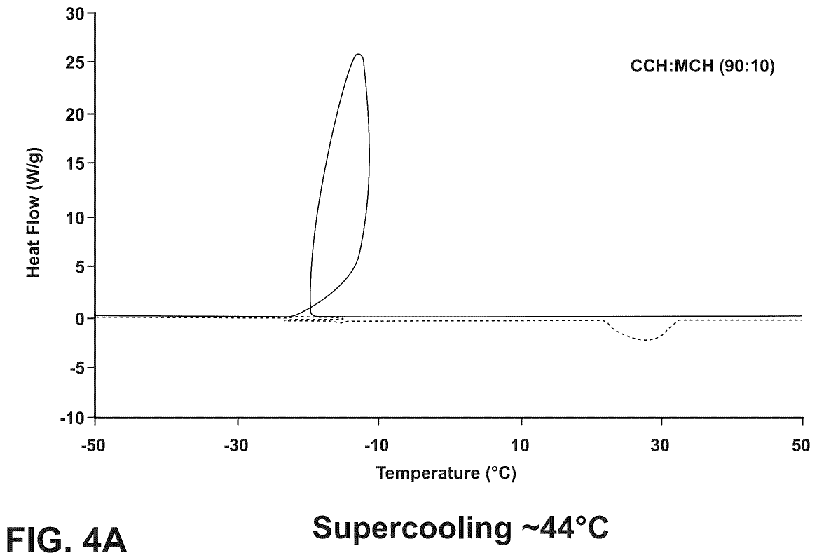

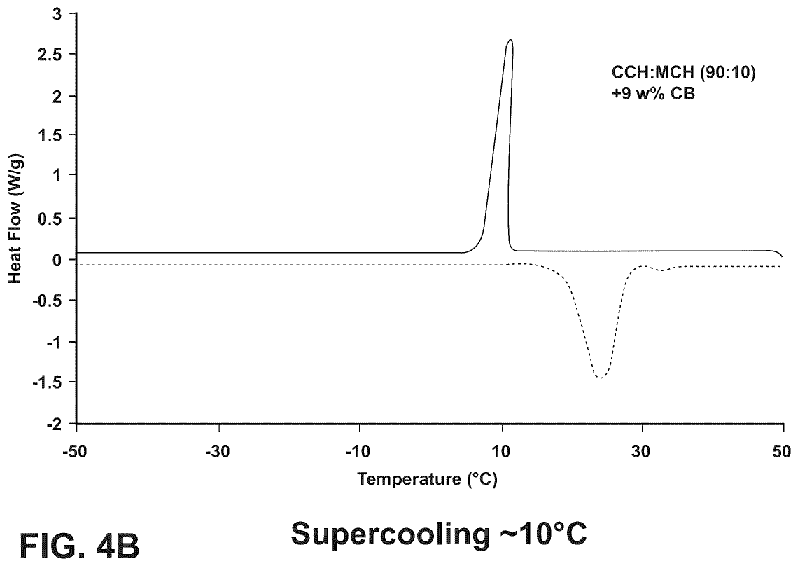

Addition of salt additives to the 90:10 CCH:MCH composition was then conducted in order to depress the melting point and reduce the supercooling. Initially, various mixtures were prepared in which 1 wt. % of salts such as potassium chloride, sodium chloride, zinc nitrate hexahydrate, strontium chloride hexahydrate, and calcium bromide (CB) were added to samples of the 90:10 CCH:MCH composition. As shown in FIG. 2, compared to the base mixture (CCH:MCH-90:10), all but one of the salt additives resulted in reducing the melting enthalpy (i.e., energy storage capacity), while only CB increased the melting enthalpy with a concurrent slight increase in the melting temperature. To further characterize the impact of CB as an additive, various mixtures were prepared including 1, 2, 3, 5, 7, and 9 wt. % of CB in the CCH:MCH-90:10 binary eutectic mixture. As shown in FIG. 3, when the CB concentration was increased, the melting point was depressed; however, the melting enthalpy also slightly decreased (by ˜10 J/g). For example, at a CB concentration of 9 wt. %, the melting point was lowered to 24° C. while the storage capacity (enthalpy) was still high. Furthermore, as shown in FIG. 4 (melting curve on top, freezing curve below, supercooling temp being the difference between the peaks), the supercooling was depressed from 44° C. for the CCH:MCH-90:10 binary eutectic mixture to 10° C. for the mixture of 90:10 CCH:MCH with 9 wt. % CB. Thus, the supercooling was significantly reduced by the addition of CB to the eutectic mixture of CCH and MCH salt hydrates.

The cycling stability of the composition of 90:10 CCH:MCH with 9 wt. % CB was also tested. This composition exhibited a melting enthalpy of 163 J/g and melting peak of 24° C. after 5 melting-and-freezing cycles. The melting temperature, however, shifted to higher temperatures after 150 cycles.

Next, the addition of other bromide salt additives to the 90:10 CCH:MCH composition was conducted. The addition of 1, 3, and 5 wt. % of potassium bromide to the CCH:MCH-90:10 binary eutectic mixture resulted in a minimal decrease in the melting temperature (27° C. to 26.1° C.), but the degree of supercooling did not decrease. The addition of 1, 3, 5, 7, and 9 wt. % copper (I) bromide to the CCH:MCH-90:10 binary eutectic mixture resulted in a small decrease in the melting temperature (27° C. to 25.8° C.), but the degree of supercooling did not decrease and the melting enthalpy significantly decreased (˜170 J/g to ˜80 J/g). The addition of 1, 3, 5, 7, and 9 w % magnesium bromide (MB) to the CCH:MCH-90:10 binary eutectic mixture resulted in a significant, large decrease in the melting temperature, but the degree of supercooling did not decrease.

Further, two compositions including the CCH:MCH-90:10 binary eutectic mixture combined with two salt additives were prepared. The first composition was a combination of the CCH:MCH-90:10 binary eutectic mixture with 2.5 wt. % CB and 2.5 wt. % CB. This first composition still exhibited a relatively large degree of supercooling. The second composition (“Example I”) was a combination of the CCH:MCH-90:10 binary eutectic mixture with 5 wt. % CB and 5 wt. % CB. Example I resulted in both a reduction in melting temperature as well as a significant reduction in the degree of supercooling. The composition of Example I is shown in Table 1 below.

TABLE 1
Composition of Example I

| Component | Weight Percent (wt. %) |
|---|---|
| Calcium chloride hexahydrate (CCH) | 81 |
| Magnesium chloride hexahydrate (MCH) | 9 |
| Magnesium bromide (MB) | 5 |
| Calcium bromide (CB) | 5 |

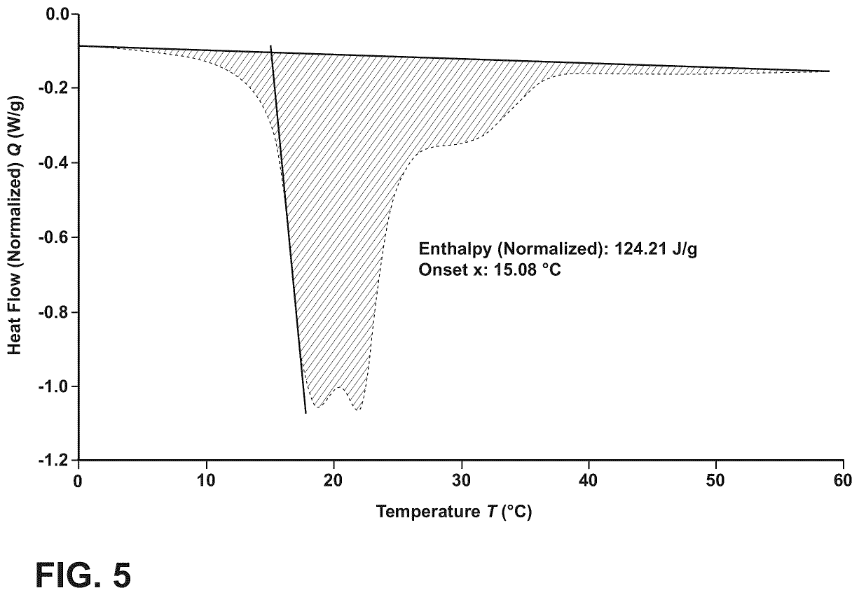

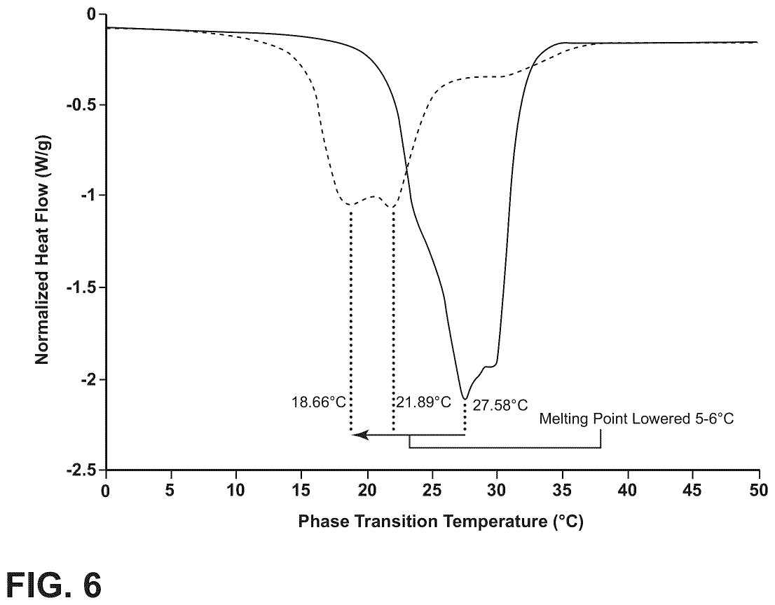

The gravimetric energy density of Example I was calculated at 124.21 J/g as shown in FIG. 5. Further, as shown in FIG. 6, the phase change temperature started at 15.08° C., the first melting peak appeared at 18.66° C., and the second melting peak appeared at 21.89° C. Thus, the melting temperature of Example I (having the CB and MB added to the CCH:MCH-90:10 binary eutectic mixture) dropped in the range of 5 to 6° C. in comparison to the pure CCH:MCH-90:10 binary eutectic mixture (having a melting temperature of approximately 27.5° C., e.g., 27.58° C.).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A phase change material composition for latent heat storage, the phase change material composition comprising:
a mixture of two or more salt hydrates, the mixture having a melting temperature above room temperature; and
at least one salt additive, each salt additive being one selected from a bromide salt and a bromide salt hydrate;
wherein the at least one salt additive decreases the melting temperature of the mixture and reduces a degree of supercooling of the mixture.

2. The phase change material composition of claim 1, wherein the mixture of two or more salt hydrates is a eutectic mixture.

3. The phase change material composition of claim 1, wherein the mixture of two or more salt hydrates is a mixture of calcium chloride hexahydrate (CaCl₂·6H₂O) and magnesium chloride hexahydrate (MgCl₂·6H₂O).

4. The phase change material composition of claim 3, wherein the mixture of calcium chloride hexahydrate and magnesium chloride hexahydrate is an approximately 90:10 mixture by weight.

5. The phase change material composition of claim 1, wherein the at least one salt additive includes one or more of: calcium bromide (CaBr₂), magnesium bromide (MgBr₂), strontium bromide (SrBr₂), strontium bromide hydrate (SrBr₂·nH₂O), potassium bromide (KBr), and sodium bromide (NaBr).

6. The phase change material composition of claim 1, wherein the at least one salt additive includes both calcium bromide and magnesium bromide.

7. The phase change material composition of claim 1, wherein each salt additive has a divalent cation.

8. The phase change material composition of claim 1, wherein each salt additive is present in an amount in a range of approximately 1 to 9 percent by weight based on a total weight of the phase change material composition.

9. The phase change material composition of claim 8, wherein each salt additive is present in an amount of approximately 5 percent by weight based on a total weight of the phase change material composition.

10. The phase change material composition of claim 1, wherein the melting temperature of the phase change material composition is in a range of approximately 15 to 25° C.

11. The phase change material composition of claim 1, wherein the degree of supercooling of the phase change material composition is approximately 15° C. or less.

12. The phase change material composition of claim 1, wherein a latent heat of the phase change material composition is in a range of approximately 120 to 170 J/g.

13. A thermal energy storage system comprising the phase change material composition of claim 1.

14. The thermal energy storage system of claim 13, further comprising one of a heating/cooling unit and building insulation.

15. The thermal energy storage system of claim 14, wherein the heating/cooling unit is a heat pump.

16. A method of heat management in a thermal energy storage system, the method comprising:
providing the phase change material composition of claim 1; and
exchanging thermal energy between the phase change material composition and another medium;
whereby the phase change material composition stores and releases thermal energy at or near room temperature.

17. The method of claim 16, wherein the thermal energy storage system includes one of a heating/cooling unit and building insulation.

18. The method of claim 17, wherein the heating/cooling unit is a heat pump.
